(19) United States
(12) Patent Application Publication
(10) Pub. No.: US 2012/0077367 A1
(43) Pub. Date: Mar. 29, 2012

(54) CABLE ASSEMBLY WITH AN IMPROVED SHELL

(75) Inventors: PING-SHENG SU, New Taipei (TW); YONG-HUA SHI, Kunshan (CN); LI-ZHI HUANG, Kunshan (CN)

(73) Assignee: HON HAI PRECISION INDUSTRY CO., LTD., New Taipei (TW)

(21) Appl. No.: 13/241,260

(22) Filed: Sep. 23, 2011

(30) Foreign Application Priority Data
Sep. 23, 2010 (CN) 201020540521.3

(51) Int. Cl. H01R 13/6581; H01R 13/58

(52) U.S. Cl. 439/455; 439/607.01

(57) ABSTRACT

A cable assembly comprises an insulative housing having a pair of positioning protrudings extending outwardly from the surface thereof, a plurality of conductive terminals received in the insulative housing, a cable having a number of wires electronically connected to the conductive terminals, a no metal cove having a receiving space surrounded by a plurality of walls for enclosing the insulative housing and a pair of positioning holes defined respectively on the surface of two walls, communicated with the receiving space and respectively receiving the positioning protrudings of the insulative housing.

### FIELD OF THE INVENTION

The present invention relates to a cable assembly, and more particularly to a cable assembly with an improved shell.

### DESCRIPTION OF PRIOR ART

For the improvement of the technical requirement, many technical solutions have been proposed. CN Pat. No. CN201081834Y, issued on Jul. 2, 2008, disclosed a cable assembly including an insulative main housing having a mating interface, a plurality of terminals located in the insulative main housing and exposed out of the mating interface, a first metal cover, a second metal cover and an insulative cover. The first metal cover is made of plate and includes a front portion enclosing the insulative main housing and a rear portion extending rearwardly from the rear end of the front portion and forming half frame structure. The second metal cover is fastened on the rear portion of the first metal cover to form an integrated frame structure. A junction line is formed between the first metal cover and the second metal cover, and the junction line may be split during in the using time. Thus, the function preventing EMI can be weaken. Another junction line is formed on the connection of two edges end of the front portion. If the insulative main housing is bigger, the junction may be opened when the housing is being assembled into the first metal portion. Then the shape of the first metal cover may be changed and can not make the cable assembly mate to the complementary connector.

As discussed above, an improved cable assembly overcoming the shortages of existing technology is needed.

### SUMMARY OF THE INVENTION

Accordingly, an object of the present invention is to provide a cable assembly for assembling conveniently and preventing EMI well .

In order to achieve the above-mentioned objects, A cable assembly comprises an insulative housing having a pair of positioning protrudings extending outwardly from the surface thereof, a plurality of conductive terminals received in the insulative housing, a cable having a number of wires electronically connected to the conductive terminals, a no-joint-line metal cove having a receiving space surrounded by a plurality of walls for enclosing the insulative housing and a pair of positioning holes defined respectively on the surface of two walls, communicated with the receiving space and respectively receiving the positioning protrudings of the insulative housing.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention;

FIG. 2 is an exploded, perspective view of the cable assembly shown in FIG. 1 ;and

FIG. 3 is a view similar to FIG. 2, from another aspect.

### DETAILED DESCRIPTION OF PREFERRED EMBODIMENTS

Reference will now be made to the drawing figures to describe the present invention in detail.

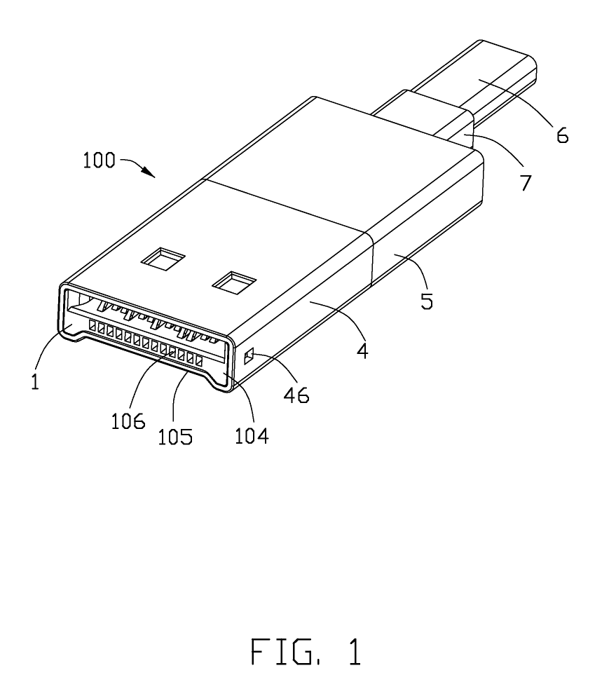

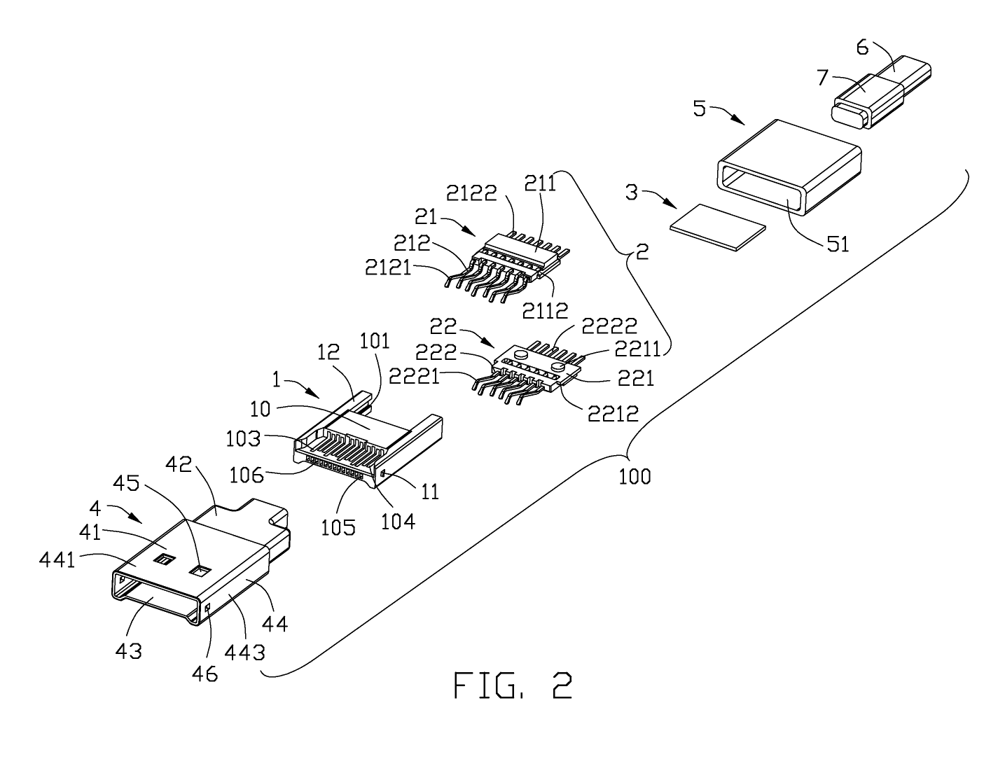

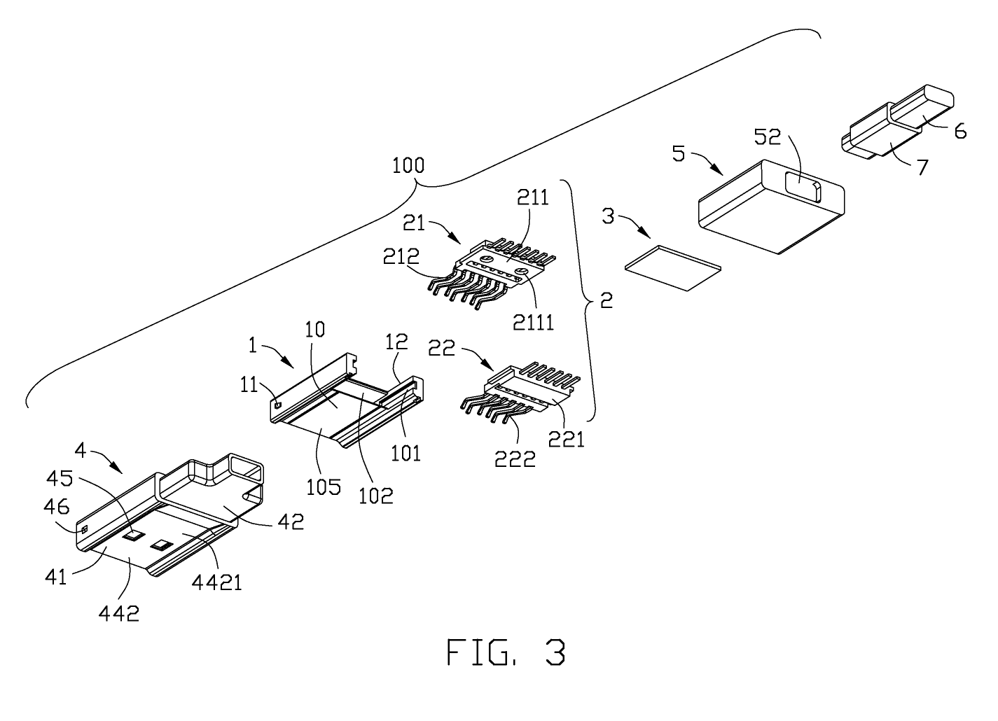

Referring to FIGS. 1 to 3, a cable assembly 100 in accordance with the present invention comprises a pair of terminal moldings 2 having a plurality of conductive terminals, an insulative housing 1 accommodating the terminal moldings 2, a PCB (printed circuit board) 3 behind the insulative housing 1, a metal cover 4 enclosing the insulative housing 1 and the PCB 3, an outer cover 5 installed on the surface of the metal cover 4, a cable 6 having a number of wires (not shown) and a strain relieving element 7.

The insulative housing 1 comprises a main portion 10, a pair of positioning protrudings 11 formed respectively on two sides of the main portion 10 and a pair of arm portions 12 extending rearwardly from two sides of main portion 10. A pair of opposite slits 101 are recessed outwardly respectively from an inner surface of the arm portion 12. A receiving cavity 102 is recessed forwardly from a rear end of the main portion 10. A recessing portion 104 is formed on an upper surface of main portion 10. The recessing portion 104 defines a plurality of amounting slots 103 communicating with the receiving cavity 102. The main portion 10 also defines a groove 105 located on the front thereof and recessed upwardly from the lower surface thereof and a number of mounting holes 106 located on the mid thereof and recessed rearwardly from the front surface thereof The mounting holes 106 are respectively communicated with the mounting slots 103.

The terminal molding 2 comprises a first terminal molding 21 and a second terminal molding 22. The first terminal molding 21 comprises a first plastic block 211 and a plurality of conductive terminals 212 integrated with the first plastic block 211. The conductive terminals 212 include signal terminals and grounding terminals. The front end of grounding terminals are beyond the front end of the signal terminals. Each of conductive terminals 212 comprises a mating portion 2121 exposing on the front of the first plastic block 211, a retaining portion (not shown) received in the first plastic block 211 and a soldering portion 2122 exposing on the rear of the first plastic block 211. The first plastic block 211 defines a pair of positioning holes 2111 and a pair of first positioning ribs 2112 integrally formed on opposite sides thereof.

The second terminal molding 22 comprises a second plastic block 221 and a plurality of conductive terminals 222 integrated with the second plastic block 221. The conductive terminals 222 include signal terminals and grounding terminals too. The front end of grounding terminals are beyond the front end of the signal terminals. Each of conductive terminals 222 comprises a mating portion 2221 exposing on the front of the second plastic block 221, a retaining portion (not shown) received in the second plastic block 221 and a soldering portion 2222 exposing on the rear of the second plastic block 221. The second plastic block 221 defines a pair of positioning posts 2211 protruding upwardly from the upper surface thereof and respectively corresponding with the positioning holes 2111 of the first plastic block 211 and a pair of second positioning ribs 2212 integrally formed on opposite sides thereof.

The metal cover 4 is die-casting and no-joint-line structure. The metal cover 4 comprises a front cover 41 and a rear cover 42 behind the front cover 41 and recessing inwardly from the outer surface thereof The metal cover 4 also has a receiving space 43 surrounded by a plurality of walls 44 and passed through the front and rear surface thereof The walls 44 comprises an upper wall 441, a lower wall 442 and two lateral walls 443 connecting the upper wall 441 to the lower wall 442. A groove 4421 is recessed upwardly from the lower wall 442. A pair of fastening slots 45 are defined on the upper wall 441 and the lower wall 442 for fastening on a complementary connector. A pair of positioning holes 46 are respectively defined on the lateral walls 443 and communicated with the receiving space 43 for corresponding to the positioning protrudings 11 of the insulative housing 1. In other embodiments, the positioning holes 46 may locate on the other positions of the metal cover 4, and the positions of the positioning protrudings 11 are changed. A step is formed between the front cover 41 and the rear cover 42.

The outer cover 5 is made from metal material, and in other embodiment, the outer cover 5 also can be made from plastic or other insulative material. The outer cover 5 has a recessing space 51 recessing rearwardly from the front surface thereof and a through hole 52 penetrating the rear wall thereof The recessing space 51 receives the rear cover 42 of the metal cover 4.

In assembly, the first terminal molding 21 is assembled on the second terminal molding 21 together. The mating portions 2121, 2221 of the conductive terminals 212, 222 are arranged in a row, and the soldering portions 2122, 2222 are arranged in two rows along up and down direction. The first and second terminal moldings 21, 22 are assembled in the receiving cavity 102 of the insulative housing 1. The first and second plastic blocks are located between the arm portions 12. The first and second positioning ribs 2112, 2212 are respectively received in the slits 101. Each of soldering portions 2122, 2222 of the conductive terminals are respectively soldered on a front end of a conductive film (not shown) located on the upper and lower surfaces of the PCB 3 and the wires of the cable 6 (not shown) are respectively soldered on a rear end of the conductive film (not shown).

The metal cover 4 is assembled on the outer surface of the insulative housing 1 forward from the rear end of the cable 6. The insulative housing 1 is received in the receiving space 43 of the metal cover 4 and the outer surface of the insulative housing 1 is fit with the inner surface of the receiving space 43. The rear surface of the receiving space 43 is attached to the rear surface of the insulative housing 1. The positioning protruding 11 is respectively assembled in the positioning hole 46 of the metal cover 4 for the insulative housing 1 firmly connecting to the metal cover 4. As integrated, the metal cover 4 is not easy deformation. The PCB 3 and the front of the cable 6 received in the receiving space 43 of the metal cover 4.

The cable 6 is passed through the recessing space 51 and through hole 52 of the outer cover 5. The front surface of the outer cover 5 is attached to the rear surface of the front cover 41. The rear cover 42 is received in the recessing space 51 of the outer cover 5 and both are interference. At least the outer surfaces of three of walls 44 of the front cover 41 are aligned to the outer surface of the outer cover 5. The strain relieving element 7 is molded on the connection point between the rear surface of the outer cover 5 and the cable 6. The strain relieving element 7 is attached to the rear surface of the outer cover 5 to make the outer cover 5 do not backwardly.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable assembly, comprising:
an insulative housing having a pair of positioning protrudings extending outwardly from a surface thereof, respectively;
a plurality of conductive terminals received in the insulative housing;
a cable having a number of wires electronically connected to the conductive terminals;
a no-joint-line metal cove having a receiving space surrounded by a plurality of walls for enclosing the insulative housing; and
a pair of positioning holes defined respectively on the surfaces of two walls, communicated with the receiving space and respectively receiving the positioning protrudings of the insulative housing.

2. The cable assembly as recited in claim 1, wherein the cable assembly further comprises a PCB received in the receiving space and respectively connected to the conductive terminals and the wires.

3. The cable assembly as recited in claim 1, wherein the metal cover has a front cover and a rear cover behind the front cover, the section size of the rear cover is smaller than the front cover's.

4. The cable assembly as recited in claim 3, wherein the cable assembly further comprises an outer cover assembled on the rear cover.

5. The cable assembly as recited in claim 4, wherein the front surface of the outer cover is attached to the rear surface of the front cover.

6. The cable assembly as recited in claim 4, wherein the outer cover is interference with the rear cover.

7. The cable assembly as recited in claim 4, wherein the front portion of the cable is received in the rear cover.

8. The cable assembly as recited in claim 4, wherein the outer surface of three of walls of the front cover are combined to the outer surface of the outer cover.

9. The cable assembly as recited in claim 1, wherein the cable assembly further comprises a strain relieving element molded on the cable and attached to a rear surface of the metal cover.

10. The cable assembly as recited in claim 1, wherein the cable assembly further comprises at least a plastic block enclosing the conductive terminals, the insulative housing further comprises a main portion and a pair of arm portions extending rearwardly from rear end of the main portion, a pair of slits are respectively recessed outwardly from the inner surface of the arm potions, a pair of positioning ribs is respective defined on the lateral sides of the plastic block and respectively received in the slits.

11. A cable assembly, comprises:
an insulative housing defining a pair of positioning protrudings;
a plurality of conductive terminals received in the insulative housing;
a cable having a number of wires electrically connected to the conductive terminals;
a no-joint-line metal cover having a front cover enclosing the insulative housing and a rear cover receiving the cable; and
a pair of positioning holes defined on a surface of the front cover and respectively receiving the positioning protrudings for firmly fastening on the insulative housing.

12. The cable assembly as recited in claim 11, wherein the metal cover is die-casting.

13. The cable assembly as recited in claim 11, wherein the cable assembly further comprises an outer cover receiving the rear cover.

14. The cable assembly as recited in claim 13, wherein the outer cover is made from metal material.

15. The cable assembly as recited in claim 13, wherein the outer cover is made from insulative material.

16. A cable connector assembly comprising:
an insulative housing defining a mating portion thereof;
at least one terminal module forwardly assembled to the housing and including a plurality of contacts with front contacting sections exposed upon the mating portion and rear mounting sections;
a printed circuit board located behind the terminal module with a front edge region to mechanically and electrically connected to the mounting sections of the corresponding contacts;
a cable defining a plurality of wires mechanically and electrically connected to a rear edge region of the printed circuit board; and
a die cast metallic shell defining a front cover enclosing the mating portion and a rear cover having a cross-section being smaller than that of the front cover; wherein
the rear cover defines a front section enclosing the printed circuit board and a rear section enclosing front portions of the wires.

17. The cable connector assembly as claimed in claim 16, wherein the front section of the rear cover defines a cross-section larger than that of the rear section of the rear cover.

18. The cable connector assembly as claimed in claim 17, wherein the cross-section of the rear section of the rear cover is similar to that of the cable.

19. The cable connector assembly as claimed in claim 16, further including another terminal module stacked with the terminal module in a vertical direction under condition that the contacting sections of both terminal modules are arranged in one row while the mounting sections of both the terminal modules are arranged in two rows.

20. The cable connector assembly as claimed in claim 16, further including a boot enclosing a rear cover and essentially circumferentially coplanar with the front cover.
